(19) United States
(12) Patent Application Publication
(10) Pub. No.: US 2013/0066754 A1
(43) Pub. Date: Mar. 14, 2013

(54) CHILD SUPPORT MANAGEMENT SYSTEM AND METHOD

(71) Applicant: Sherilyn ATWOOD, Santa Clara, CA (US)

(72) Inventor: Sherilyn ATWOOD, Santa Clara, CA (US)

(73) Assignee: ITTAVI, INC., Santa Clara, CA (US)

(21) Appl. No.: 13/615,161

(22) Filed: Sep. 13, 2012

Related U.S. Application Data
(60) Provisional application No. 61/534,794, filed on Sep. 14, 2011.

(51) Int. Cl. G06Q 10/00; G06Q 40/00

(52) U.S. Cl. 705/30

(57) ABSTRACT

A method and system for facilitating child support management are disclosed. In a first aspect, the method comprises providing a child support management system between two parties, wherein the child support management system includes a central repository to store joint documents. The method includes managing expenses incurred by at least one of the two parties and automatically calculating an amount owed by at least one of the two parties, wherein the amount owed is communicated by the child support management system to each of the two parties. In a second aspect, a system comprising a processor and a memory device coupled to the processor, carry out the steps provided by the method.

### CROSS-REFERENCE TO RELATED APPLICATION

This application claims benefit under 35 USC 119(e) of U.S. Provisional Patent Application No. 61/534,794, filed on Sep. 14, 2011, entitled “SUPPORT MANAGEMENT SYSTEM,” which is incorporated herein by reference in its entirety.

### FIELD OF THE INVENTION

The present invention relates to computer-implemented support systems, and more particularly, to a child support management system.

### BACKGROUND

In the United States (2010), there are approximately 39 million parents exchanging approximately $200 Billion in yearly child support payments. To contribute to the best interests of the child, the non-custodial parent if often ordered to pay child support which includes but is not limited to monetary monthly payments, reimbursement for incremental expenses as well as critical additional expenses such as health care, education expenses, child care or any other additional expenses incurred to support the child(ren).

Once a child support order or agreement has been established, the parents of the child(ren) conventionally have two options to manage the exchange of money and the payment of the child support. The first option is to use government child support agencies. The second option is to manage the payments manually. The state government agencies are ineffective because each state system is built on a unique and proprietary infrastructure that cannot communicate with other infrastructures. In addition, the state systems do not manage incremental expenses. Manually managing child support payments is complicated and disruptive, leading to many financial disagreements between the parents. In either case, there is no standard child support system and process that can be leveraged by parents to manage base and incremental child support payments.

Accordingly, there is a strong need for a cost-effective and transparent child support management system that facilitates communication and payments between the parents and third parties. The present invention addresses such a need.

### SUMMARY

A method and system for facilitating child support management are disclosed. In a first aspect, the method comprises providing a child support management system between two parties, wherein the child support management system includes a central repository to store joint documents. The method includes managing expenses incurred by at least one of the two parties and automatically calculating an amount owed by at least one of the two parties, wherein the amount owed is communicated by the child support management system to each of the two parties.

In a second aspect, a system comprises a processor and a memory device coupled to the processor, wherein the memory device includes an application which, when executed by the processor, causes the system to provide a child support management system between two parties, wherein the child support management system includes a central repository to store joint documents, manage expenses incurred by at least one of the two parties, and automatically calculate an amount owed by at least one of the two parties, wherein the amount owed is communicated by the child support management system to each of the two parties.

### BRIEF DESCRIPTION OF THE DRAWINGS

The accompanying figures illustrate several embodiments of the invention and, together with the description, serve to explain the principles of the invention. One of ordinary skill in the art readily recognizes that the particular embodiments illustrated in the figures are merely exemplary, and are not intended to limit the scope of the present invention.

FIG. 1 illustrates a method for facilitating child support management in accordance with an embodiment.

FIG. 2 illustrates a method for setting up accounts in the child support management system in accordance with an embodiment.

FIG. 3 illustrates a method for managing reoccurring expenses in accordance with an embodiment.

FIG. 4 illustrates a method for managing additional expenses in accordance with an embodiment.

FIG. 5 illustrates a method for paying expenses in accordance with an embodiment.

### DETAILED DESCRIPTION

The present invention relates to computer-implemented support systems, and more particularly, to a child support management system. The following description is presented to enable one of ordinary skill in the art to make and use the invention and is provided in the context of a patent application and its requirements. Various modifications to the described embodiments and the generic principles and features described herein will be readily apparent to those skilled in the art. Thus, the present invention is not intended to be limited to the embodiments shown but is to be accorded the widest scope consistent with the principles and features described herein.

A method and system in accordance with the present invention provides an effective, non-disruptive system (e.g. website, web application, or mobile application) to facilitate communication and child support related expenses and payments between parents. By providing a child support management system, that includes a central repository to store joint documents, between two parties, managing expenses incurred by at least one of the two parties, and calculating an amount of child support owed by at least one of the two parties, the amount of child support owed is communicated by the child support management system to each of the two parties to enable the streamlined payment of child support expenses.

To describe the features of the present invention in more detail, refer now to the following description in conjunction with the accompanying Figures.

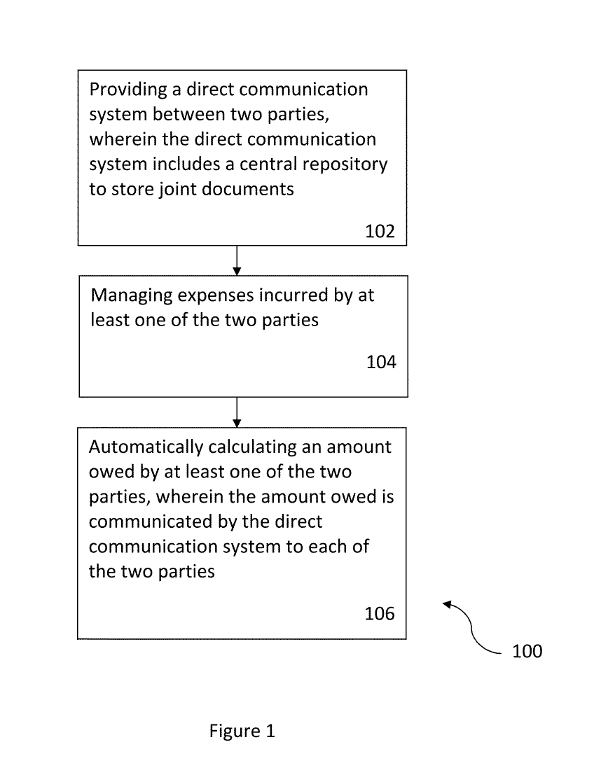

FIG. 1 illustrates a method 100 for facilitating child support management in accordance with an embodiment. The method 100 comprises providing a child support management system to enable direct communication between two parties, wherein the child support management system includes a central repository to store joint documents, via step 102. In one embodiment, the child support management system is any of a web, mobile, and tablet based social networking platform that is capable of managing multiple children and multiple child support cases at once as well as facilitating child support payments between the parents and third parties. In another embodiment, the child support management system facilitates the exchange of information between every unique state government child support operating system and any agency involved in enforcing child support orders including but not limited to the IRS, DMV, and passport agencies.

The method 100 includes managing expenses incurred by at least one of the two parties, via step 104, and automatically calculating an amount owed by at least one of the two parties, wherein the amount owed is communicated by the child support management system to each of the two parties, via step 106. In one embodiment, the expenses are entered into the child support management system in a variety of ways including but not limited to either party manually entering the expenses or automatic entering of the expenses based upon previously entered party information and credentials. In another embodiment, information in the central repository is leveraged and shared by the child support management system to automatically complete various legal forms.

In one embodiment, the two parties are two parents of a child whose support payments are at issue and the joint documents stored by the central repository include but are not limited to physical and electronic copies of receipts, invoices, legal documents, divorce decrees, support orders, settlements, and child related information such as report cards, awards, and pictures. The messaging communications between parties, whether parents or a third party, is tracked by the child support management system.

In one embodiment, the managing step 104 of the method 100 further comprises tracking both reoccurring and additional expenses incurred by each of the two parents and providing a receipt to facilitate transparency between the two parents. The reoccurring expenses include but are not limited to any of a pre-determined monthly expense amount, an amount set by courts, base child support, alimony, spousal support, and pension payments. The additional expenses are incremental expenses that the two parents incur over the life of the child based upon various activities, the child's age, and the time of year and include but are not limited to any of clothing costs, shelter costs, medical bills and health care, education fees, daycare fees, and extracurricular activities of the child.

In one embodiment, the method 100 further includes facilitating payments made by at least one of the two parties to the other one of the two parties, facilitating payments made by at least one of the two parties directly to a third party, wherein the other one of the two parties is notified of the payments made directly to the third party, and automatically calculating a remaining amount or balance owed by at least one of the two parties to ensure that payment obligations are met by each of the two parties.

Accordingly, the child support management system both tracks, records, and facilitates payments that occur directly between the parents themselves with no government worker involvement and tracks, records, and facilitates payments that occur directly between one of the two parents and a third party. In another embodiment, the child support management system tracks, records, and facilitates payments that occur from a third party to at least one of the two parents.

In one example, if a child of two parents has incurred an additional incremental expense including but not limited to a daycare cost, the child support management system enables the payor parent to directly pay the third party daycare facility for the daycare cost incurred by the child thereby bypassing paying the other parent. In this example, the payee is the third party directly and so the non-payor payment will receive a notification of the daycare cost payment from the child support management system.

If payments by either parent are inadequate, missing, or late, the remaining amount automatically calculated also includes but is not limited to any of a state mandated interest rate and a late payment fee. In one embodiment, the child support management system determines any past due expenses past a predetermined time period including but not limited to 30 days. In this embodiment, the child support management system calculates a new balance based upon a unique monthly interest rate specified by each of the U.S. state governments. The unique monthly interest rate is determined by the child support management system via a lookup table.

In one embodiment, an additional payment amount is calculated by multiplying the principal amount of the expense by the unique monthly interest rate over a past due time period. The child support management system updates the amount due and sends a notification message to at least each of the two parents notifying them of the past due amount and new total amount due.

In one embodiment, the method 100 further includes tracking communications by each of the two parties to the child support management system and notifying at least one of the two parties regarding the communications to ensure each of the two parties is actively involved. The communications include but are not limited to status updates and updates on child events.

One of ordinary skill in the art readily recognizes that the child support management system can include a variety of features including but not limited to an external website with a home page and login module; a support management main site with a dashboard, payment reports, all reports module, expenses module, payments module, all documents module, document images, receipt images, account management module, payor (party making payments) and payee (party receiving payments) lists, children and parent information modules, support order details, payee details, and merchant details; a registration wizard with a checklist, user info and no info modules, children and parent sign up modules, case modules, additional case modules, payment method setup, financial institution, payment gateway, or paypal setup; popup windows comprising viewing documents, adding payees, merchants, expenses, documents, folders, dispute forms, and paying expenses; and error & help messages and that would be within the spirit and scope of the present invention.

In one embodiment, the dashboard of the support management main site includes a to do list module, a quick links module, an expenses organized by time module, an expenses organized by category module, and a history module showing account changes over a predetermined time period including but not limited to 60 days. The do list module includes the ability to reply to disputes, review documents and receipts, and pay current expenses and expenses that are past due.

In this embodiment, the quick links module includes the ability to pay expenses, add/edit expenses, add/edit payees, add/edit merchants, add/edit documents, add/edit reports, and send messages to other parties or users of the child support management system. The history module organizes payments into sections comprising past due payments, pending payments, and historical payments. Items listed under the past due payments section can either be paid or disputed. Items listed under the historical payments section are sortable by various dropdowns including but not limited to status, due date, payee name and type, merchant name and type, and category.

When viewing the reports module of the dashboard, a variety of reports are creatable including but not limited to custom reports and standard reports. In one embodiment, custom reports are sortable by various dropdowns including but not limited to status, due date, payee name and type, merchant name and type, and category. Standard reports include but are not limited to payments made and payments received each in year to date, last twelve months, and previous tax year views, and total expenses in category, payee, and merchant views. These reports can be leveraged by either party and can also serve as certified third party proof for an external third party including but not limited to the IRS or judicial entities.

When viewing the expenses module, both reoccurring and additional expenses are displayed and sortable by various dropdowns including but not limited to status, due date, payee name and type, merchant name and type, and category. A variety of actions can be applied to each of the expenses including but not limited to archiving, editing, deleting, and disputing. Additionally, when viewing the payments module, both reoccurring and additional expenses are payable and sortable by various dropdowns including but not limited to status, due date, payee name and type, merchant name and type, and category. A variety of actions can be applied to each of the payment items including but not limited to paying, disputing, and selecting for additional information or options. The payments module enables each of the parents to be paid directly or a third party merchant or business or individual to be paid directly by either of the parents.

When viewing the documents module, both random documents and receipts are displayed and editable/creatable. Documents serve to store, archive and share information specific and relevant to the child(ren) or legal aspects between the parents. Random documents include but are not limited to divorce agreements, support orders, and report cards of the child. Folders are creatable and editable to further organize the various documents by categories and types. Various versions are produced for each of the documents and receipts for easy viewing/sorting. Smaller versions of the document displays a small sized image of a cover page of the document, a document name, a date added, a category, and a link to open a full version of the document. Smaller versions of the receipt displays a small sized image of a cover page of the receipt, a date, a merchant name, an amount, a category, and a link to open a full version of the receipt.

When viewing the account management module, various sections are displayed including but not limited to children, parents, support orders, payees, and merchants. Key details for all of these sections are listed in an organized and easily viewable fashion. Additional data is creatable to each of these sections which are also editable. One of ordinary skill in the art readily recognizes that a variety of data can be editable for both the children and the parents including but not limited to name, address, city, relationship, employment status, employer name, and contact information and that would be within the spirit and scope of the present invention.

In one embodiment, the support orders section of the account management module includes case information, orders, and documents and the information stored is editable. One of ordinary skill in the art readily recognizes that a variety of information can be included in the case information including but not limited to court name, county, branch, mailing address, contact information, case number, and key financial details and that would be within the spirit and scope of the present invention.

In this embodiment, in the payee and merchant section of the account management module, all payee and merchants are organized alphabetically or by a different sorting mechanism including but not limited to date and type. The lists display both payees and merchants already utilized but also potential payees and merchants for future use. Viewing one of either the payees listed or merchants list displays a module that includes a variety of editable information and pertinent documents, receipts, and reoccurring/additional expenses associated with that payee to efficiently organize all information on a single support system viewing area.

When viewing the registration wizard, key pieces of information are initially gathered from the parties involved in the child support dispute including but not limited to name, address, case number, case effective date, judgment/order location, children names, gender, and dates of birth, support orders such as child support, alimony, healthcare, parent/guardian information, and payment/paypal/financial information. This enables the child support management system to automatically compile information related to the child support dispute and to begin leveraging the information to fill out various legal forms that may be required. When a party logs in for the first time, they are able to provide the other party or parent's email address/contact information so that they are automatically prompted to sign up as well.

After the initial registration step, additional information is gathered concerning the child support case information including but not limited to a petitioner name, a respondent name, an official case number, a state where the order was or will be established, an expected date when the order was or will be established, a court name, a court county location, and a court branch name. The parties can input official case numbers or create a temporary case number while an officially state recognized case number is generated. Additionally, multiple case numbers can be registration at the same time during the registration wizard process. Furthermore, additional information is gathered concerning the children and parents involved and any support orders.

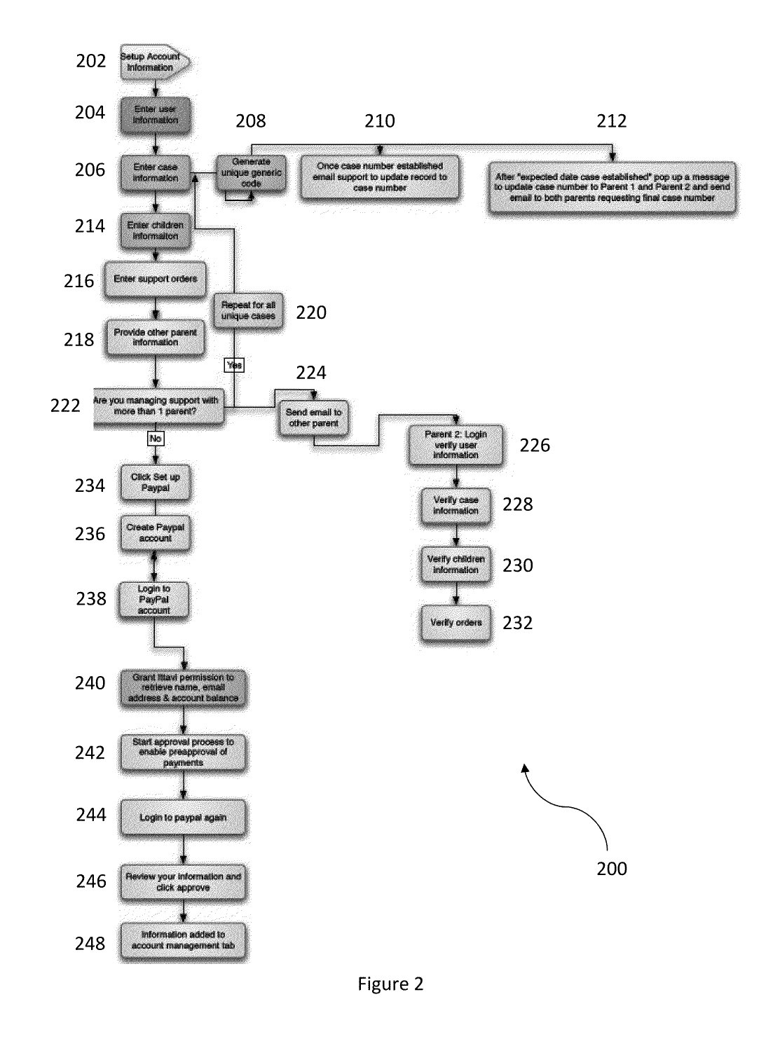

FIG. 2 illustrates a method 200 for setting up accounts in the child support management system in accordance with an embodiment. The method 200 includes setting up account information, via step 202, entering party/parent (user) information, via step 204, and entering child support case information, via step 206. If an official case number isn't available, a unique generic code is generated by the child support management system, via step 208, and once an official case number is established the system is contacted to update the case number, via step 210. Additionally, after an expected date for an official case number to be established has passed, both parties/parents are notified to enter in the official (final) case number, via step 212.

The method 200 further includes entering children information, via step 214, entering support order information, via step 216, and entering other party/parent information, via step 218. For each additional case being managed, steps 214-218 are repeated, via step 220. The method 200 prompts whether more than one party/parent is managing support, via step 222. If yes, an email is sent to the other party/parent, via step 224, and the other party/parent will login and verify user information, via step 226, will verify case information, via step 228, will verify children information, via step 230, and will verify support orders, via step 232.

The method 200 returns to steps 234-238 to setup a financial institution account including but not limited to a paypal financial account. The method 200 includes giving the child support management system access and permission to retrieve various information including but not limited to name, email, address, account information from the financial institution, via step 240. In one embodiment, the child support management system is named Ittavi for “it takes a village”. The method 200 starts a preapproval process to enable payments, via step 242, logs back into the financial institution, via step 244, prompts for review and approval of account information, via step 246, and then completes the process of adding information to the account management, via step 248.

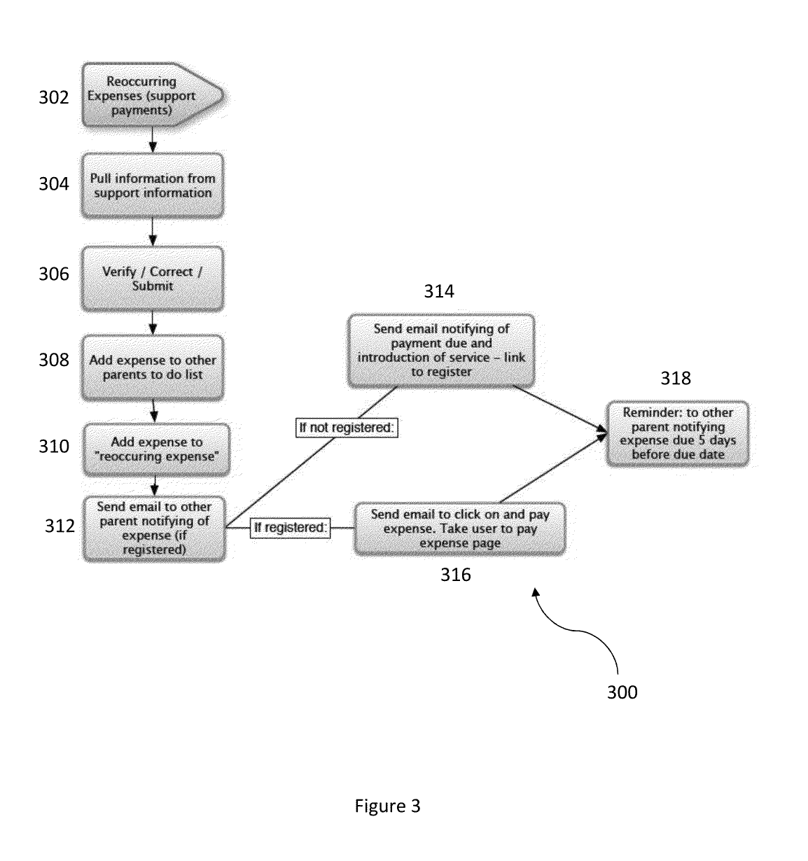

FIG. 3 illustrates a method 300 for managing reoccurring expenses in accordance with an embodiment. The method 300 includes accessing reoccurring expenses including but not limited to support payments, via step 302, and viewing information from support order information, via step 304. The support order information is verified, edited, corrected, and submitted, via step 306, and an expense is added to the other party or parent to do list, via step 308.

The method 300 further includes adding the expense to the reoccurring expense list, via step 310, and sending a notification message or email to the other party or parent notifying him/her of the expense if registered, via step 312. If the other party or parent is not registered, they are notified of the payment due and introduced to the child support management system to register, via step 314. If the other party or parent is registered, they are notified of the payment due and able to setup payment of the reoccurring expense directly on the expense page, via step 316. The method 300 includes a creating reminders with predetermined time periods to notify each party or parent of expenses with upcoming due dates, via step 318.

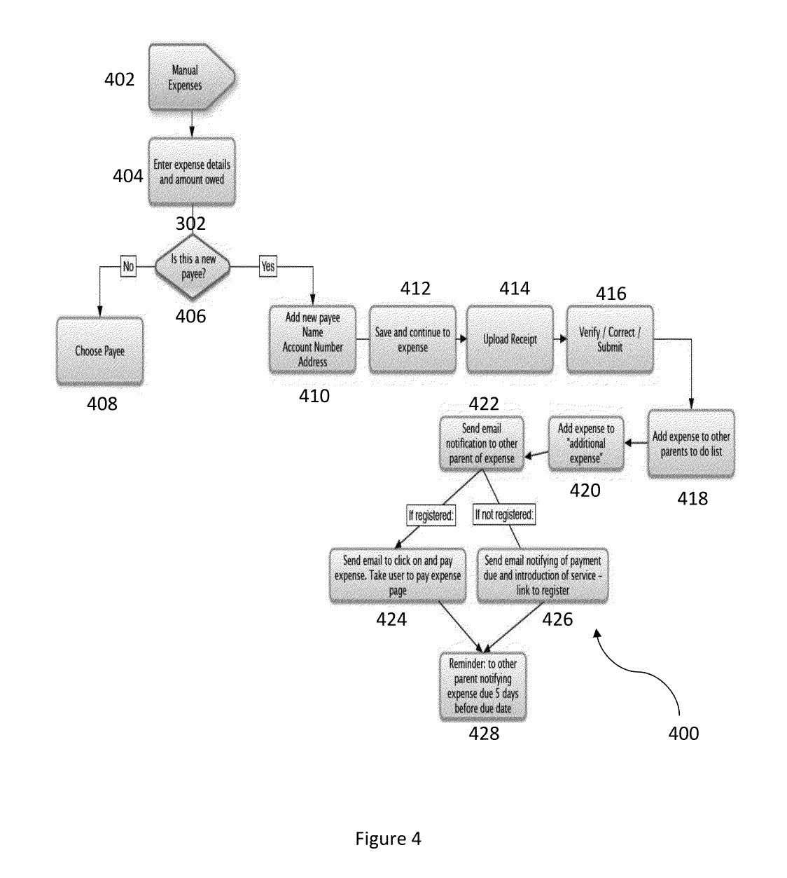

FIG. 4 illustrates a method 400 for managing additional expenses in accordance with an embodiment. The method 400 includes accessing manual or additional expenses, via step 402, and entering an expense detail and amount owed, via step 404. This information may be collected manually or automatically through data integration methods between the child support management system and financial institutions. The method 400 prompts whether this is a new payee, via step 406, and if not, then a payee is chosen, via step 408, and if yes, then the new payee name, account number, address, and other pertinent information is entered or verified via automated data collection, via step 410, and saved, via step 412. The method 400 includes uploading a receipt for the expense or verifying details automatically provided via data integration methods, via step 414, and verifying, editing, correcting, and submitting the receipt, via step 416.

Once submitted, the expense is added to the other party or parent to do list, via step 418, and is added to the additional expenses list, via step 420. The method 400 sends a notification message or email to the other party or parent regarding the newly added expense, via step 422. If the other party or parent is registered, they are notified of the payment due and able to setup payment of the reoccurring expense directly on the expense page, via step 424. If the other party or parent is not registered, they are notified of the payment due and introduced to the child support management system to register, via step 426. The method 400 includes a creating reminders with predetermined time periods to notify each party or parent of expenses with upcoming due dates, via step 428.

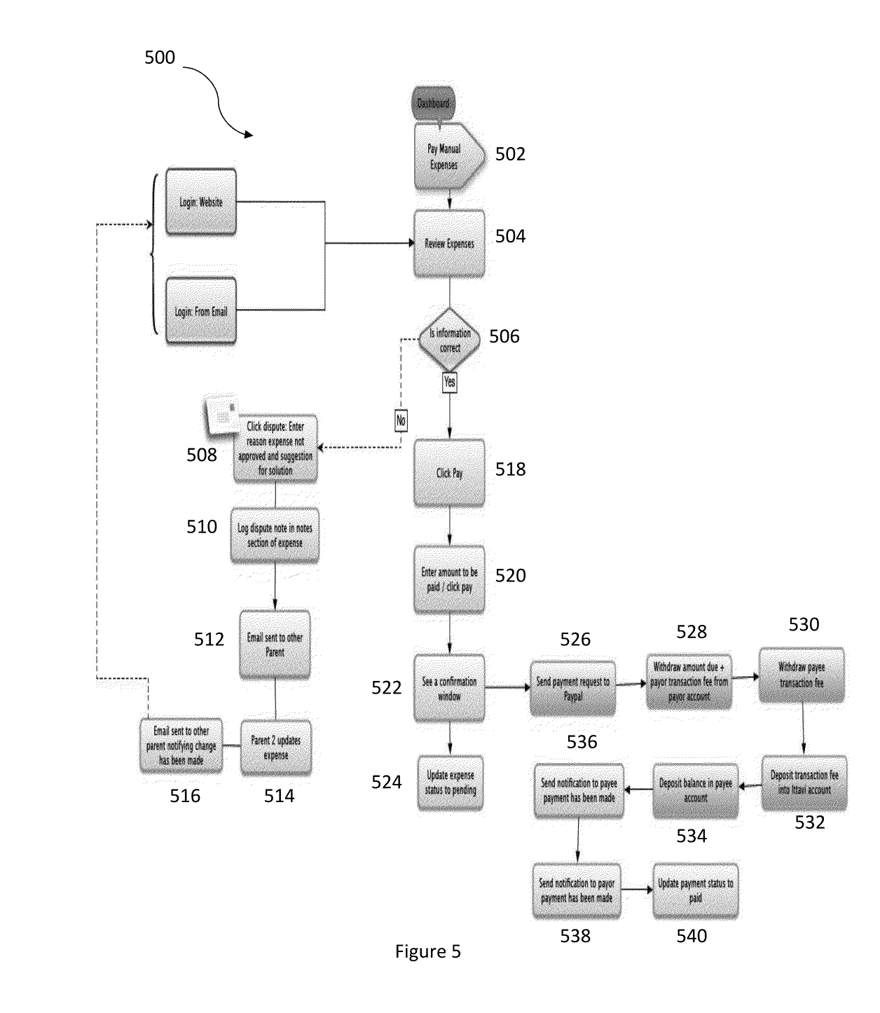

FIG. 5 illustrates a method 500 for paying expenses in accordance with an embodiment. The method 500 includes accessing the dashboard and payments module, via step 502, and reviewing the expenses after either logging via the system or an email notification, via step 504. The method 500 prompts whether the information is correct, via step 506. If not, a dispute form is accessed and information is entered regarding potential issues with the expense and solutions, via step 508. The dispute form notes are logged, via step 510, and communicated to the other party or parent, via step 512. The other party or parent updates the expense in accordance with the dispute form, via step 514, and a notification message is sent to the disputing party or parent stating that changes have been made, via step 516. The method 500 repeats these steps until the information is deemed correct, via step 506.

If the expenses information is reviewed and determined to be correct, a payment submission mechanism (e.g. pay button) is clicked, via step 518, and the amount to be paid is entered, via step 520, resulting in a confirmation window, via step 522, and the expense status is update to a pending status, via step 524. Once confirmed, the method 500 sends the payment request to the financial institution, via step 526, and the amount is withdrawn from the financial account of the paying party or parent associated with the financial institution, via step 528.

The method 500 withdraws a payee transaction or subscription fee, via step 530, deposits this payee transaction fee into a system account, via step 532, and deposits the expense amount paid by the payor less the payee transaction fee into the payee account, via step 534. Notification messages are sent to both the payee and the payor via steps 536 and 538 respectively and the method 500 updates the expense status from pending to paid, via step 540.

As above described, the method and system allow for managing the exchange of money and the payment of child support between at least the two parents. By creating a child support management system that includes but is not limited to a web-based social platform, the financial security provided to children via child support payments covering reoccurring and additional expenses is streamlined. The child support management system operates without government worker interference and provides tools that automate child support information population into the child support management system and that enable both parties/parents to manage, track, and make direct payments of all expenses in a timely and transparent fashion.

A method and system for facilitating child support management has been disclosed. Embodiments described herein can take the form of an entirely hardware implementation, an entirely software implementation, or an implementation containing both hardware and software elements. Embodiments may be implemented in software, which includes, but is not limited to, application software, API integration, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium is any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-RAN).

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for facilitating child support management, the method comprising:
providing a child support management system to enable direct communication between two parties, wherein the child support management system includes a central repository to store joint documents;
managing expenses incurred by at least one of the two parties; and
automatically calculating an amount owed by at least one of the two parties, wherein the amount owed is communicated by the child support management system to each of the two parties.

2. The method of claim 1, wherein the joint documents stored by the central repository include any of receipts, invoices, legal documents, divorce decrees, support orders, settlements, child related information, report cards, awards, and pictures.

3. The method of claim 1, wherein the child support management system manages multiple child support cases at once.

4. The method of claim 1, wherein managing expenses incurred by at least one of the two parties, when the two parties are two parents, further comprises:
tracking both reoccurring and additional expenses incurred by at least one of the two parents; and
providing a receipt to facilitate transparency between the two parents.

5. The method of claim 4, wherein the reoccurring expenses include any of a set expense amount each month, an amount set by courts, base child support, alimony, spousal support, and pension payments.

6. The method of claim 4, wherein the additional expenses are incremental expenses that the two parents incur over a child time period and that fluctuate depending on activities, age, and time of year, and include any of clothing, shelter, medical bills, education fees, daycare fees, and extracurricular activities.

7. The method of claim 1, further comprising:
facilitating payments made by at least one of the two parties to the other one of the two parties;
facilitating payments made by at least one of the two parties directly to a third party, wherein the other one of the two parties is notified of the payments made directly to the third party; and
automatically calculating a remaining amount owed by at least one of the two parties.

8. The method of claim 7, wherein the remaining amount owed includes a government mandated interest rate if payments were any of inadequate, missing, and late.

9. The method of claim 1, further comprising:
tracking communications by each of the two parties to the child support management system, wherein the communications include updates on child events; and
notifying at least one of the two parties regarding the updates on child events to ensure each of the two parties is actively involved.

10. The method of claim 1, further comprising:
completing legal forms automatically by leveraging information in the central repository;
providing history of past expenses and payments incurred over a predetermined time period; and
notifying third parties of child support expenses, payments, and communications incurred over a predetermined time period.

11. A system for facilitating child support management, the system comprising:
a processor; and
a memory device coupled to the processor, wherein the memory device includes an application which, when executed by the processor, causes the system to:
provide a child support management system to enable direct communication between two parties, wherein the child support management system includes a central repository to store joint documents;
manage expenses incurred by at least one of the two parties; and
automatically calculate an amount owed by at least one of the two parties, wherein the amount owed is communicated by the child support management system to each of the two parties.

12. The system of claim 11, wherein the joint documents stored by the central repository include any of receipts, invoices, legal documents, divorce decrees, support orders, settlements, child related information, report cards, awards, and pictures.

13. The system of claim 11, wherein the child support management system manages multiple child support cases at once.

14. The system of claim 11, wherein to manage expenses incurred by at least one of the two parties, when the two parties are two parents, further comprises to:
track both reoccurring and additional expenses incurred by at least one of the two parents; and
provide a receipt to facilitate transparency between the two parents.

15. The system of claim 14, wherein the reoccurring expenses include any of a set expense amount each month, an amount set by courts, base child support, alimony, spousal support, and pension payments.

16. The system of claim 14, wherein the additional expenses are incremental expenses that the two parents incur over a child time period and that fluctuate depending on activities, age, and time of year, and include any of clothing, shelter, medical bills, education fees, daycare fees, and extracurricular activities.

17. The system of claim 11, wherein the application, when executed by the processor, further causes the system to:
facilitating payments made by at least one of the two parties to the other one of the two parties;
facilitating payments made by at least one of the two parties directly to a third party, wherein the other one of the two parties is notified of the payments made directly to the third party; and
automatically re-calculate a remaining amount owed by at least one of the two parties.

18. The system of claim 17, wherein the remaining amount owed includes a government mandated interest rate if payments were any of inadequate, missing, and late.

19. The system of claim 11, wherein the application, when executed by the processor, further causes the system to:
track communications by each of the two parties to the child support management system, wherein the communications include updates on child events; and
notify at least one of the two parties regarding the updates on child events to ensure each of the two parties is actively involved.

20. The system of claim 11, wherein the application, when executed by the processor, further causes the system to:
completing legal forms automatically by leveraging information in the central repository;
providing history of past expenses and payments incurred over a predetermined time period; and
notifying third parties of child support expenses, payments, and communications incurred over a predetermined time period.
